(19) United States
(12) Patent Application Publication
(10) Pub. No.: US 2026/0328985 A1
(43) Pub. Date: Oct. 22, 2026

(54) CABINET DOOR CAPABLE OF CHANGING COLOR AND CABINET BOX

(71) Applicant: Nathan Indig, Brooklyn, NY (US)

(72) Inventors: Moses Indig, Lakewood, NJ (US); Mordechi Gluck, Brooklyn, NY (US)

(21) Appl. No.: 19/468,349

(22) Filed: Feb. 3, 2026

Related U.S. Application Data
(60) Provisional application No. 63/762,390, filed on Feb. 24, 2025.
(60) Provisional application No. 63/753,051, filed on Feb. 3, 2025.

(51) Int. Cl. F21V 8/00; A47B 96/20; A47B 97/00

(52) U.S. Cl. CPC G02B 6/0051; A47B 96/20; A47B 97/00; G02B 6/0055; G02B 6/0068; G02B 6/0073; A47B 2220/0077

(57) ABSTRACT

A cabinet door capable of changing colors includes a housing, a diffuser, an LED strip, a back plate, and a control device. The cabinet door may be synchronized with one or more additional cabinet doors to provide coordinated lighting effects. A cabinet box for use with the cabinet door includes a channel or interior space for housing wiring components.

### CROSS-REFERENCE TO RELATED APPLICATIONS

The present application claims the benefit of U.S. Provisional Application No. 63/753,051 filed Feb. 3, 2025, and U.S. Provisional Application No. 63/762,390 filed Feb. 24, 2025, the contents of each of which are incorporated herein by reference.

### TECHNICAL FIELD

The present invention relates to cabinetry doors and, more particularly, to cabinetry doors capable of changing color.

### BACKGROUND OF THE INVENTION

Cabinetry doors are a staple of any room in a home, especially, for example, a kitchen. When one is modeling or remodeling a home, the kitchen cabinets are often a costly endeavor where one must decide on a particular style, color, and material that will remain in the home for years, or decades, to come.

With advancement in color changing, light emitting diode (LED) technology, users have been able to change the color of light bulbs and light fixtures to add scenic color schemes to their homes. Some users may also add LED strips to the top or underside of their cabinetry to provide additional colors to their kitchen or other rooms, but this can often appear out of place or clash with the colors of existing kitchen cabinetry.

Thus, there is a need for a combination of LED technology and cabinetry which can provide a homeowner with a wide range of colors and designs to choose from, allowing changing of colors or designs instantaneously, or even projecting moving images for a more immersive experience. There is a further need for display cabinets which can be synchronized with one another for allowing an entire kitchen to project a single color or moving image.

A downside of current cabinets capable of changing color is the cabinet doors typically have a border around the display which reduces the immersive quality of the display. Thus, there is a need for a cabinet door capable of changing color that is substantially seamless when in operation.

### SUMMARY OF THE INVENTION

Therefore, it is an object of the present invention to provide a cabinet door capable of changing color in combination with a cabinet box.

It is another object of the present invention to have multiple cabinet doors which can operate in synchronization with one another.

These and other objects are explicitly attained by the present invention which is directed to a cabinet door having a housing, an LED strip, a light guide layer, a diffuser, a back plate, and a control device.

The control device comprises an output device receptacle, a control box, and a plug configured to supply power to the control device.

The cabinet box houses the control device, and a channel is disposed within the interior of the cabinet box for routing wiring from the cabinet door to the control device.

### BRIEF DESCRIPTION OF THE DRAWINGS

The present invention will be described in greater detail with reference to the accompanying drawings, in which

FIG. 1 is a right front perspective view from above illustrating cabinet doors capable of changing colors according to the present invention.

FIG. 2 is a bottom rear perspective view from below of the cabinet doors shown in FIG. 1.

FIG. 3A is a partial cross-sectional view of the components in a corner of the cabinet door shown in FIG. 1.

FIG. 3B is right rear perspective view of the components of the cabinet door shown in FIG. 1 with the back plate omitted.

FIG. 4A is an enlarged plan view of a corner of the cabinet door with the shown in FIG. 1 housing omitted.

FIG. 4B is an enlarged left bottom perspective view of the cabinet door shown in FIG. 1.

FIG. 5A is a partial cross-sectional view of the components in a corner of the cabinet door according to a further embodiment of the present invention.

FIG. 5B is an exploded front perspective view of the cabinet door embodiment shown in FIG. 5A.

FIG. 6 is an enlarged rear perspective view of a corner of the cabinet door with the components shown in FIG. 1.

FIGS. 7a-7c are rear plan views of the cabinet door shown in FIG. 1 shown in different size configurations.

FIG. 8 is a block diagram schematically illustrating elements of a control device for the LED matrix according to the present invention.

FIG. 9 illustrates an embodiment of a wiring diagram of the control device operating the cabinet door.

FIG. 10 is an enlarged perspective of the top of the cabinet door of FIG. 1.

FIG. 11a is a front top perspective view of a plurality of cabinet doors capable of changing color in communication with one another.

FIG. 11b is a top plan view of a plurality of cabinet doors capable of changing color in communication with one another.

FIG. 11c is a rear plan view of a plurality of cabinet doors capable of changing color in communication with one another.

FIG. 12 is a right front perspective view from above illustrating the cabinet door capable of changing colors according to an alternative embodiment.

FIG. 13 is a rear perspective view from below of the cabinet door shown in FIG. 12.

FIGS. 14a and 14b are enlarged rear perspective views of a comer of the cabinet door within the dotted circle XIV shown in FIG. 13 showing the housing assembled and disassembled.

FIGS. 15a and 15b are enlarged front perspective views of the comers of the cabinet door shown in FIGS. 14a and 14b respectively.

FIG. 16 is a partial cross-sectional view of the components in a corner of the cabinet door shown in FIG. 12.

FIG. 17 is a rear plan view of the cabinet door shown in FIG. 12.

FIG. 18 illustrates, from a bottom rear perspective view, the cabinet doors of FIG. 12 in communication with one another for a synchronized display.

FIG. 19a is a front left perspective view of a cabinet box of FIG. 1 for use with the cabinet doors capable of changing colors in an open configuration.

FIG. 19b is a front right perspective view of the cabinet box of FIG. 1 for use with cabinet doors capable of changing colors, shown in a closed configuration.

FIG. 20 is an enlarged sectional top left perspective view of the cabinet box of FIGS. 19a and 19b with the top panel omitted and a side panel in phantom.

FIG. 21a is a front left perspective view of a cabinet box of FIG. 12 for use with the cabinet doors capable of changing colors in an open configuration.

FIG. 21b is a front right perspective view of a cabinet box of FIG. 12 for use with the cabinet doors capable of changing colors in a closed configuration.

FIG. 22 is an enlarged sectional top left perspective view of the cabinet box of FIGS. 21a and 21b with the top panel omitted and a side panel in phantom.

### DESCRIPTION OF THE PREFERRED EMBODIMENTS

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms "a," "an," and "the" include the plural, and reference to a particular numerical value includes at least that particular value, unless the context clearly dictates otherwise. Ranges may be expressed herein as from "about" or "approximately" one particular value and/or to "about" or "approximately" another particular value. When such a range is expressed, another embodiment includes from the one particular value and/or to the other particular value. Similarly, when values are expressed as approximations, by use of the antecedent "about," it will be understood that the particular value forms another embodiment. It is also understood that all spatial references, such as, for example, horizontal, vertical, top, upper, lower, bottom, left, right, are for illustrative purposes only and can be varied within the scope of the disclosure.

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Reference will now be made in detail to the exemplary embodiments of the present disclosure, which are illustrated in the accompanying figures.

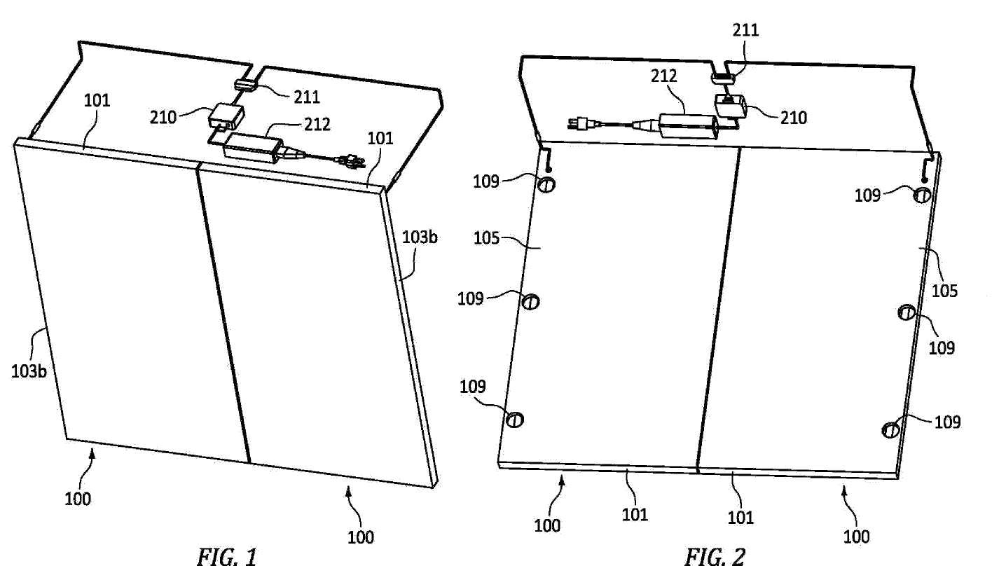

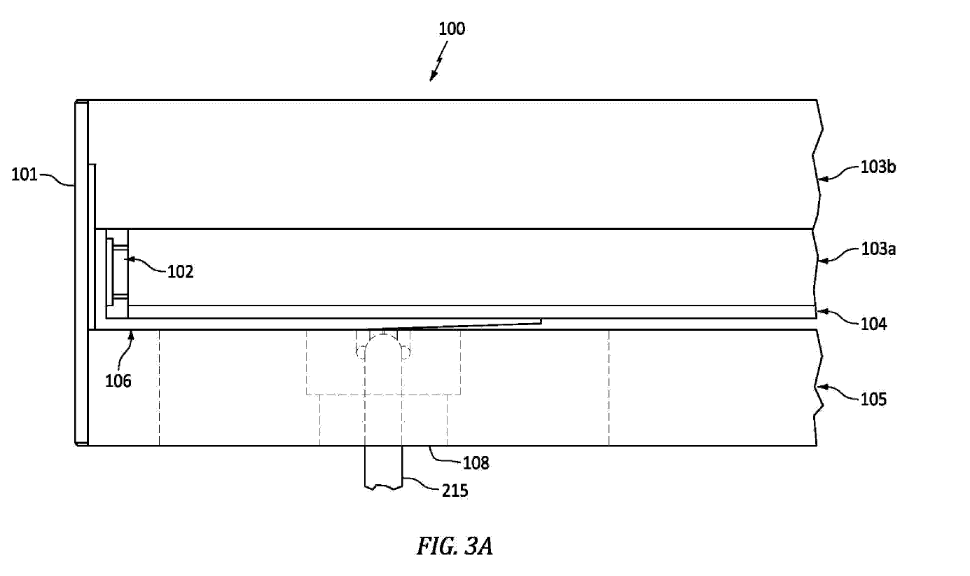

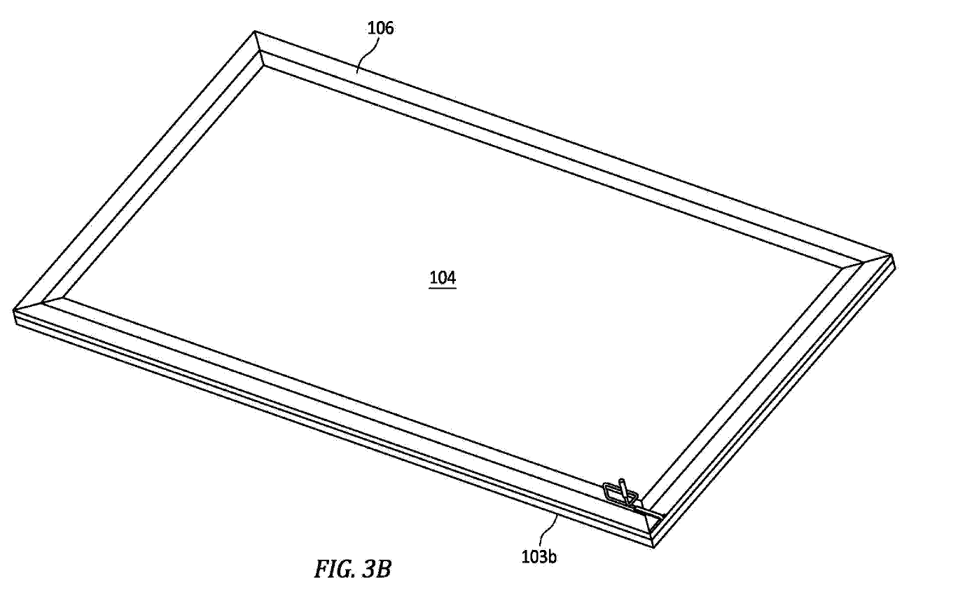

Referring to FIGS. 1-5, the cabinet door 100 has an outer perimeter housing 101 formed of a rigid material. The housing 101 can be formed from aluminum, wood, plastic, or any other material common in the construction of cabinetry. As seen in FIG. 3A, it is preferred that the housing 101 is relatively thin to create a substantially seamless and thus a more immersive display. As best seen in FIG. 3A, positioned within the space defined by the housing 101 is a strip of light emitting diodes (LED) 102 extending the length, or the substantial length, of a given side of the housing 101. The LED strip 102 is housed near at least one side of the housing 101. In a preferred embodiment, two sides, and more preferably two parallel sides, of the housing 101 contain at least one LED strip 102 adjacent thereto. It is contemplated that a housing 101 having two or more sides containing an LED strip may include either a single LED strip extending across multiple sides, with LED strips on opposing sides electrically connected through a wire, or two separate LED strips connected to a single control device. The LED strip 102 is arranged such that light is emitted towards the middle interior space defined by the housing 101. In a preferred embodiment, the LED strip 102 is mounted on an L-shaped frame 106 such that the back side of the LED strip 102 is secured within the front extending portion of the L-shaped frame 106 and the inwardly extending portion of the L-shaped frame 106 is adhered to the reflector panel 104 as best seen in FIG. 3A-3B and discussed infra. It is contemplated that the L-shaped frame 106 may be constructed of aluminum, although other rigid materials are contemplated. It is also contemplated that the L-shaped frame 106 may be adhered directly to the light guiding layer 103a.

The LED strip 102 is capable of emitting red, green and blue (RGB) light and mixtures thereof to obtain numerous color variations. Additional sub-pixel color options, including warm white, cold white, and yellow are contemplated. In a preferred embodiment, Red Blue Green Integrated Circuit (RGBIC) LEDs are used to obtain independent controls of specific LED sub-pixels. The term "strip" is used herein to refer to a series of LEDs arranged linearly. It is also contemplated that the LED strip may be dimmable.

The LED strip illuminates a light-guide layer 103a in order to evenly distribute light across the entire layer 103a. In a preferred embodiment, the light-guide layer 103a is a laser-dot acrylic panel that directs light inwardly from the edge-mounted LED strip 102. It is contemplated that other light-guide layers may be used to achieve even light distribution from at least one edge-mounted LED strip 102. The placement and spacing of the dots on the laser-dot acrylic panel 103a can be varied depending on the size and purpose of the cabinet door 100 and the LED type being used. Situated above the light-guide layer 103a is a diffuser layer 103b that projects the light outwardly to the front-facing portion of the cabinet door 100. The diffuser layer 103b can be constructed of a translucent or opaque material such as, but not limited to, acrylic, polycarbonate, methacrylate, or silicone rubber. It is contemplated that the diffuser layer 103b can be a single monolithic layer or multiple diffuser layers stacked upon one another. The relative thickness of each layer 103a and 103b can depend on the dimensions of the cabinet door 100. Beneath the light-guide layer 103a, opposite the diffuser layer 103b, is a reflective film 104 that reflects light emitted toward the back portion of the cabinet door 100 back toward the front-facing portion to improve diffusion. In a preferred embodiment, the L-shaped frame 106 is adhered to the back-facing portion of the reflective film and, preferably, surrounds the perimeter of the reflective film 104 and light-guide layer 103a. Toward the backmost section of the cabinet door 100, and beneath the layers described above, is a back plate 105 to provide support and rigidity to the door 100. The back plate 105 is preferably constructed of plywood, but other rigid materials, such as an aluminum honeycomb panel, are also contemplated.

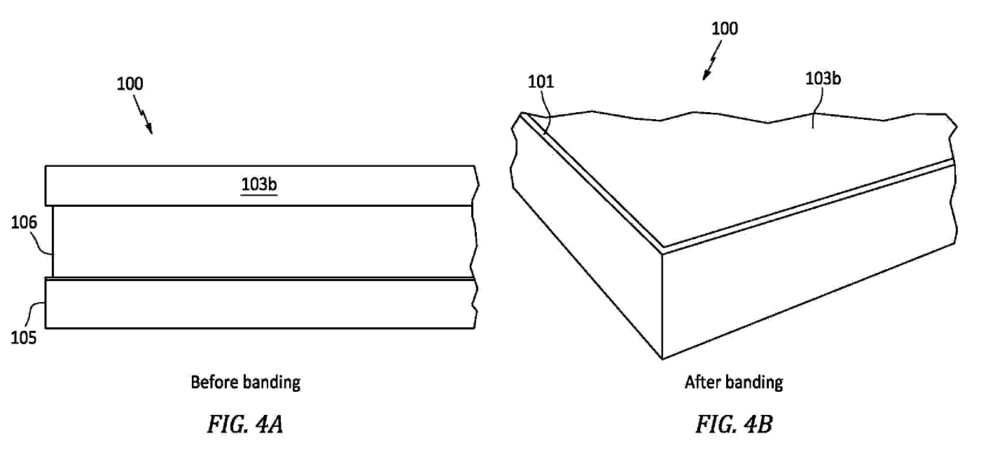

The components of the cabinet door 100 are secured by the housing 101, described supra which functions as edge banding around the outer edge of the cabinet door 100, as best seen in FIGS. 4A-4B, such that the components of the door are hidden when assembled giving the aesthetic appeal of a standard cabinet door when the color changing capabilities of the cabinet door 100 are not in use. The housing 100 secures the internal components of the cabinet door 100 together when assembled. In a preferred embodiment, the housing 101 is a singular monolithic structure surrounding the outer edge of the cabinet door 100, but may also be segmentally constructed and affixed around the side edge of the cabinet door 100. It is a feature of the present invention that the housing 101 surrounds only the side edge of each layer and is minimally visible when viewed from the front of the cabinet door to provide an immersive cabinet display experience.

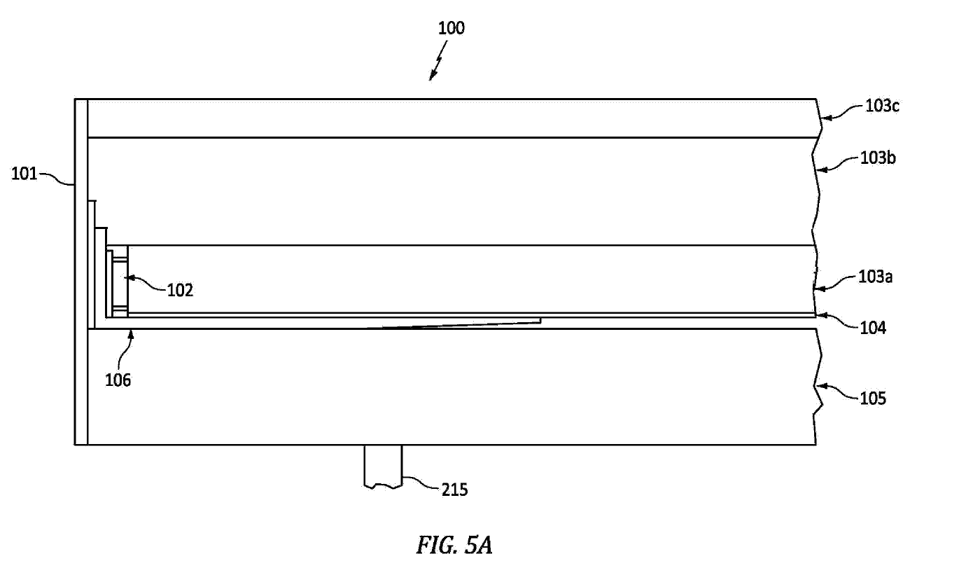

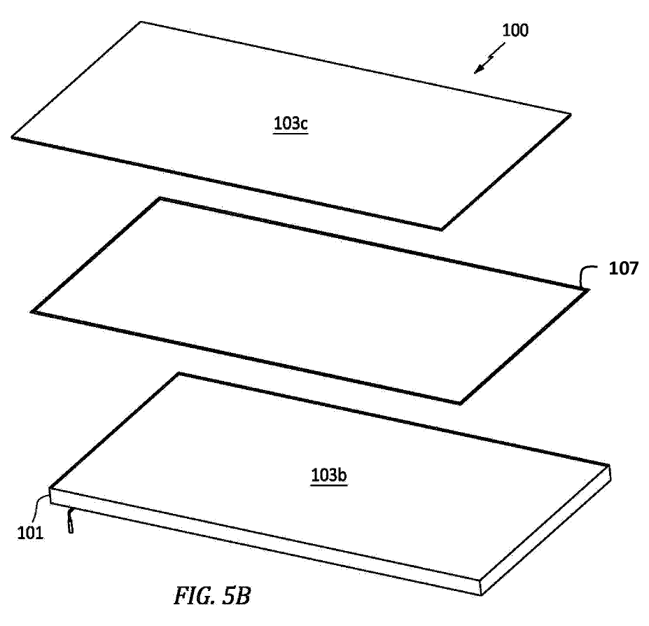

In another embodiment, as seen in FIGS. 5A and 5B, an additional layer of acrylic 103c, such as a sheet of day/night acrylic which appears as a solid color, preferably black, when unlit and another color when illuminated, may be added above the front-most facing layer of the cabinet door 100. It is contemplated that the size of the housing 101 would be modified to also surround the acrylic 103c. It is contemplated that the acrylic layer 103c would be adhered to the diffuser layer 103b by double sided adhesive tape 107 placed around the outer edge between the acrylic layer 103c and the diffuser layer 103b, although other methods of securing the acrylic layer 103c and diffuser layer 103b are contemplated.

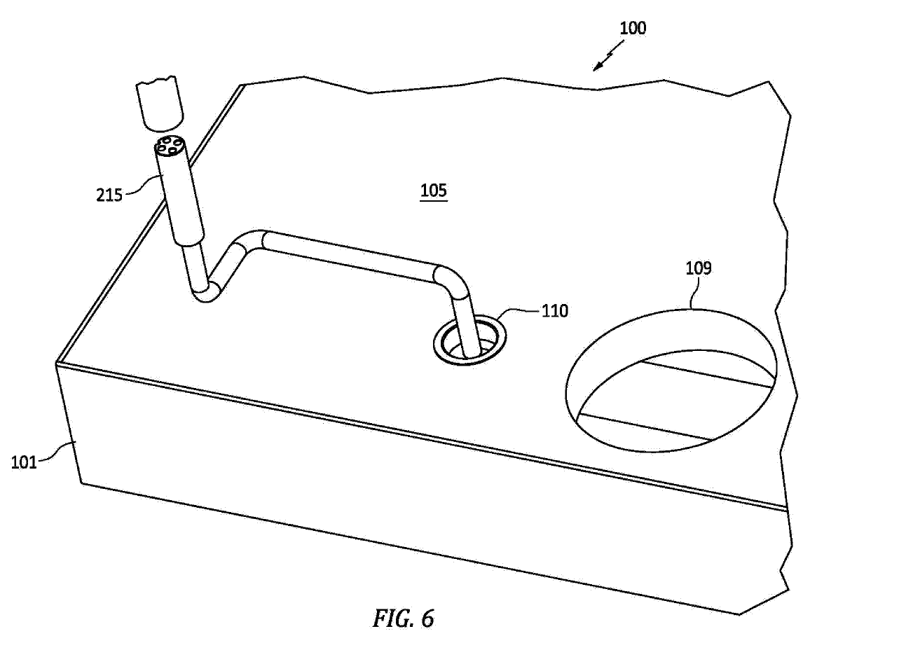

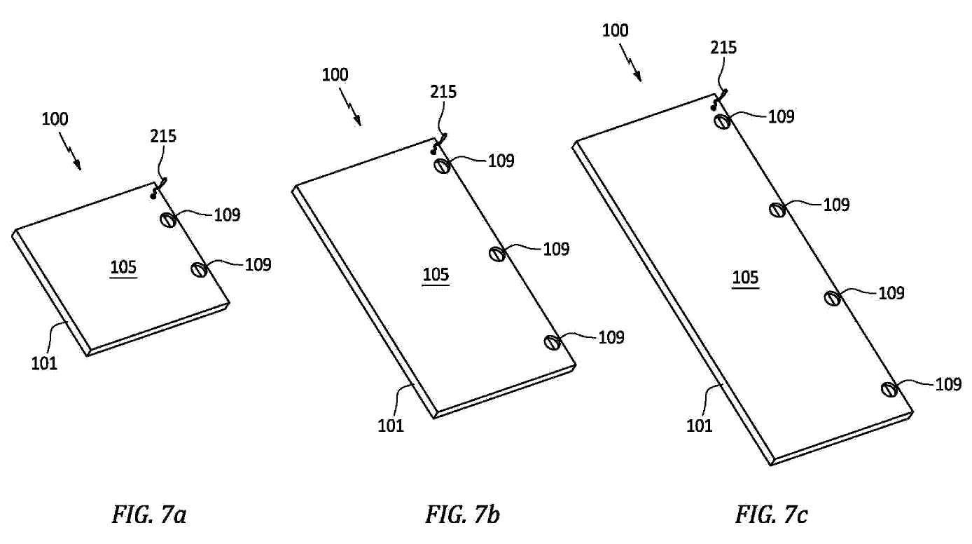

As seen in FIGS. 1-7c, a channel 108 may be provided for electrical wiring 215 to pass from the LED strip 102 and through the cabinet door 100 to an external control device 200. It is contemplated that a grommet 110 may surround the channel in order to prevent the backplate 105 from damaging the wiring 215, as seen in FIG. 6. Preferably, the channel extends from the backplate 105 and through the first inner layer 103a to connect with the LED strip. While a single channel is depicted near an edge of cabinet door 100, it is contemplated that the channel may be provided anywhere on the backplate 105 and/or housing 101. Further, additional channels may be provided for additional electrical wiring. The rear side may also contain routed attachment points 109 for attachment to a cabinetry unit by traditional hinges. It is contemplated that the cabinet door 100 can contain any number of attachment points 109 to accommodate cabinet doors 100 of varying sizes, as seen in drawings.

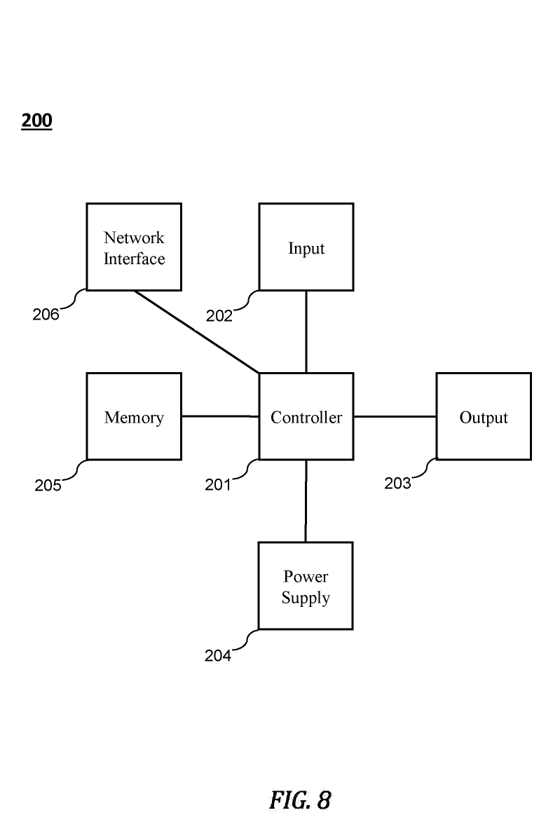

As best seen in FIG. 8, the external control device 200 may be installed separate from the cabinetry box 300 or within the cabinetry box, discussed infra. A control device 200 is provided for the operation of the LED strip 102. The control device 200 includes a controller 201, an input device 202, a power supply 204, and a memory 205 all interactively coupled to one another as shown in FIG. 8 and connectable to an output device 203 (which is the LED strip 102) for control and operation of the output device. The output device 203 constitutes the LED strip 102. An input device 202 can be a series of pre-programmed buttons capable of power, brightness, color selection, cycling through preset patterns, and the like. Additionally, the control device 200 may further include a wireless communication interface 206 for connection to a remote control, internet, or another control device. The control device 200 may be used in operation with at least one LED strip 102 within a cabinet door 100. The control device 200 may also be used to control two or more cabinet doors simultaneously. Alternatively, a plurality of control devices 200 may be wired together or wirelessly connected to provide synchronized control across said devices and corresponding cabinet doors.

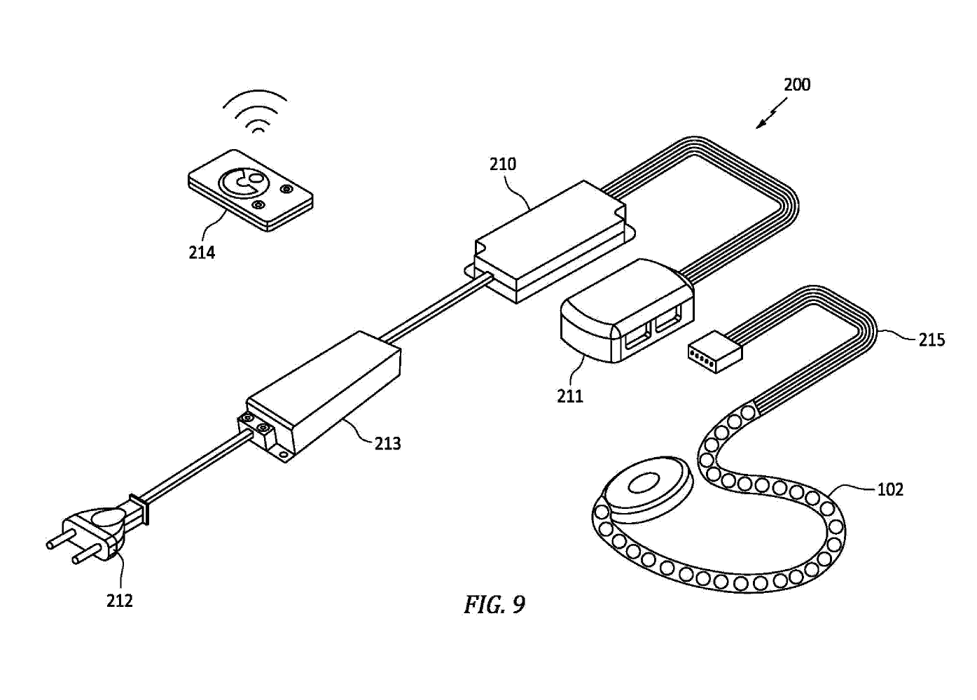

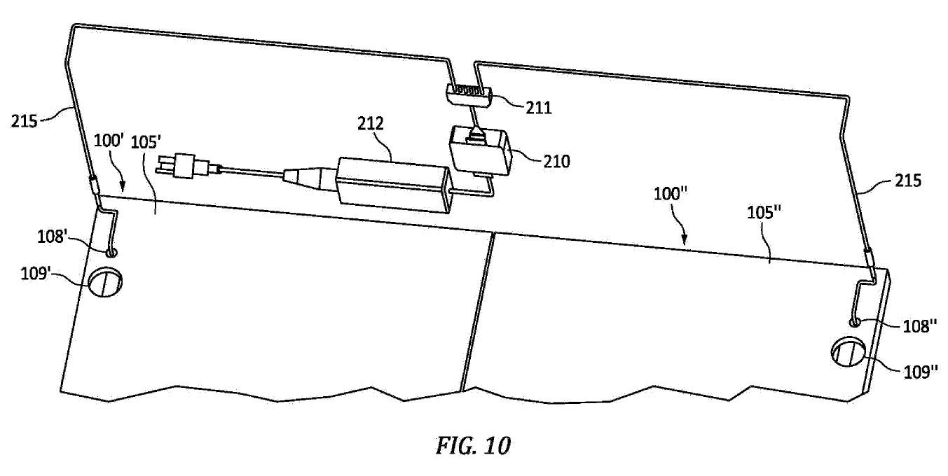

FIG. 9-10 depicts an embodiment of the control device 200 consisting of control box 210 housing the controller 201 and memory 205 in communication with an output device receptacle 211 and receiving power from plug 212. It is contemplated that an input device 202 may be connected to or housed within either the control box 210 or output device receptacle 211. Alternatively, an embodiment may be used where no input device is present and the cabinet door 100 displays a preset pattern or color stored on the memory 205. An LED driver 213 is placed between the plug 212 and control box 210 which acts as the transformer for the wiring structure. Additionally, a radio telecontrol 214 is provided which may connect to a wireless communication interface 206 located in the control box 210. It is contemplated that the wireless communication interface 206 may also be added as an additional peripheral to the wiring structure. The wiring diagrams of FIGS. 9-10 are merely exemplary, and other variations of the wiring diagram may be used as is common to one skilled in the art.

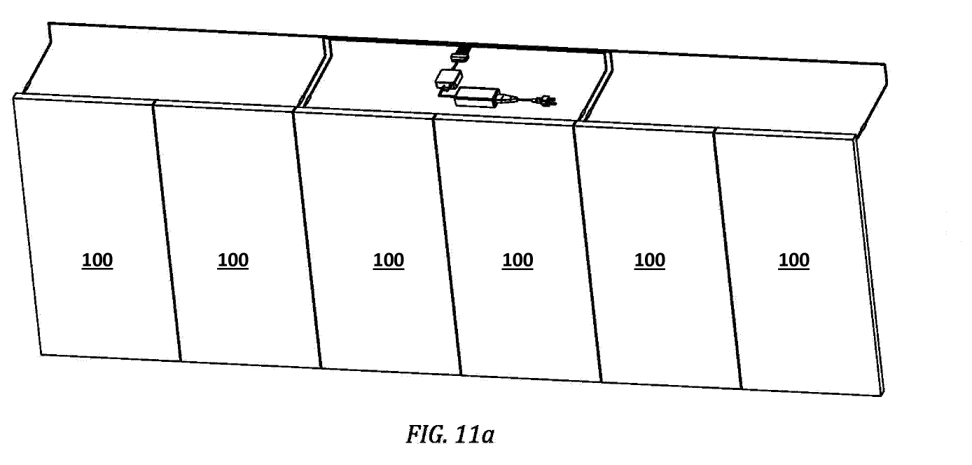

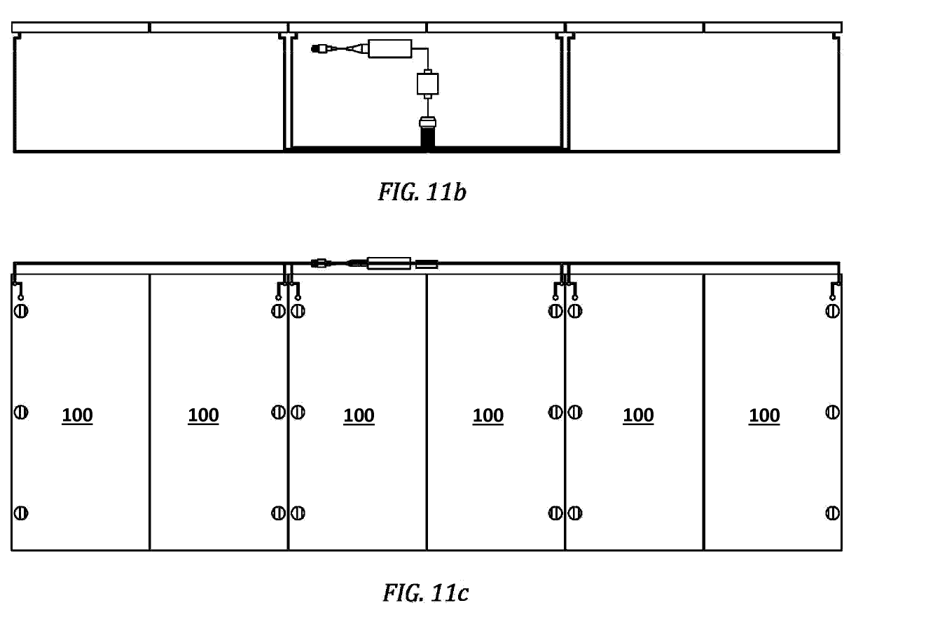

As best seen in FIGS. 10-11c, it is an advantage of the present invention that multiple cabinet doors 100 may be connected together to provide a synchronized visual display. Methods of communication between two or more cabinets unit include, but are not limited to, a direct connection between a first LED strip 102' of one cabinet door 100' to a second LED strip 102" of a second cabinet door 100"; connecting two or more LED strips 102', 102" of two cabinet doors 100', 100" to a single output device receptacle 211, connecting two or more controllers 201 wirelessly to one another, and synchronized control from a single radio telecontrol 214 capable of transmitting an Radio Frequency (RF), Infrared (IR), Bluetooth, or other wireless communication protocols of which two or more cabinet doors 100 would accept simultaneously.

It is also contemplated that the exterior facing components of the cabinet door 100, specifically the housing 101, back plate 105, and set screws 106, could be painted or coated to a color similar to the color of the diffuser 103b or acrylic layer 103c such that when the LED strip 102 is off, the cabinet door 100 appear to be one solid color.

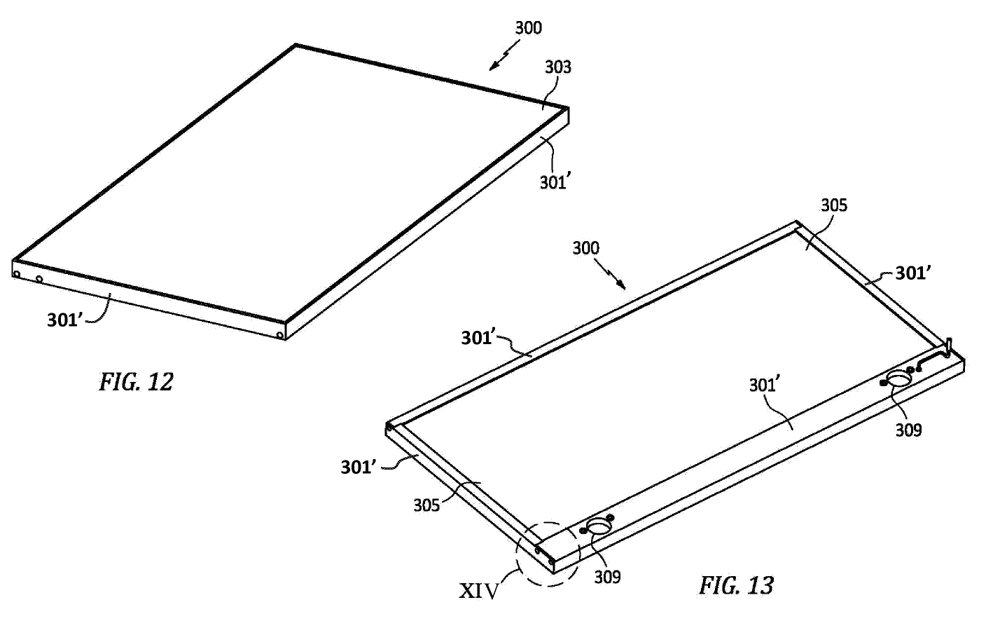

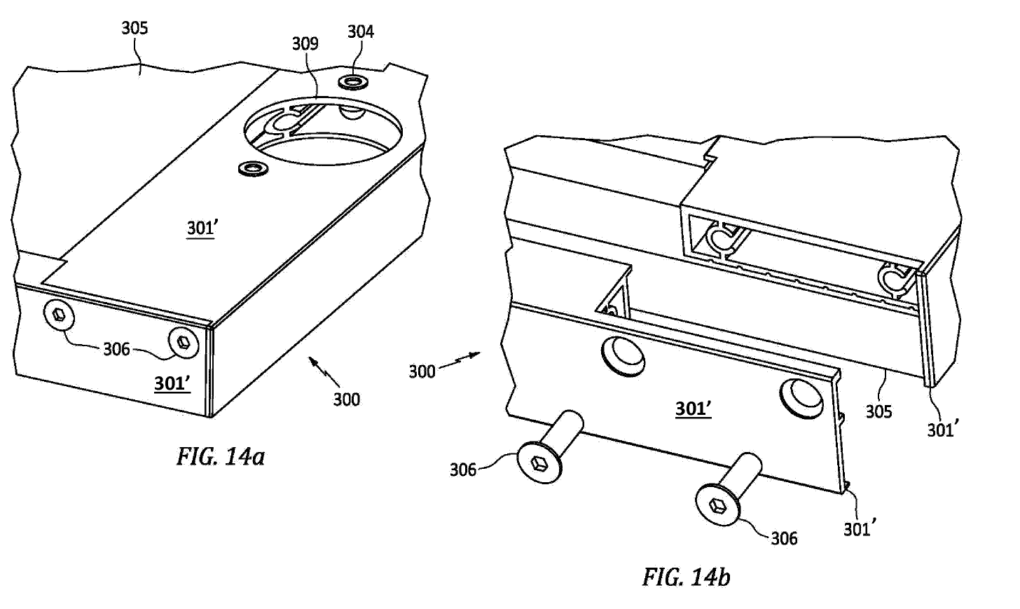

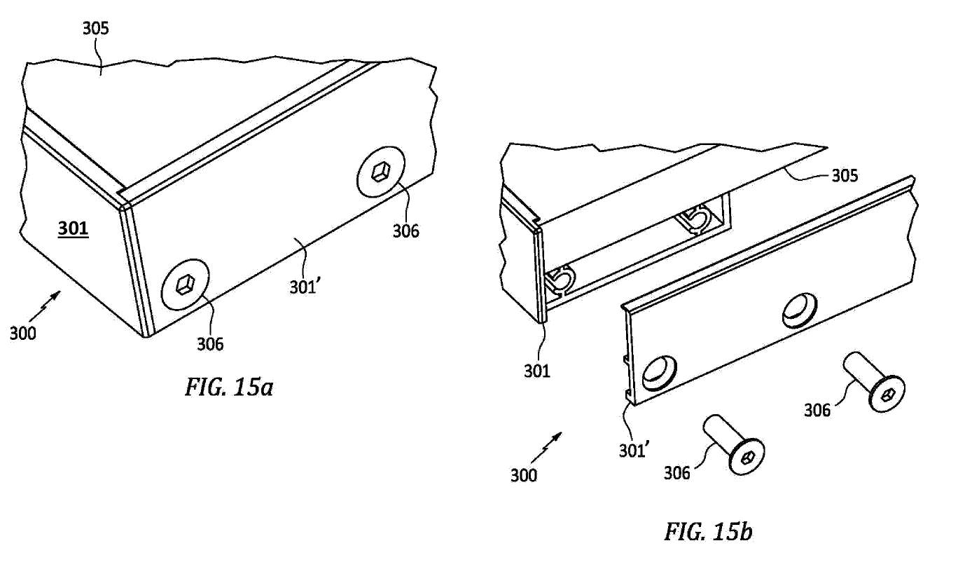

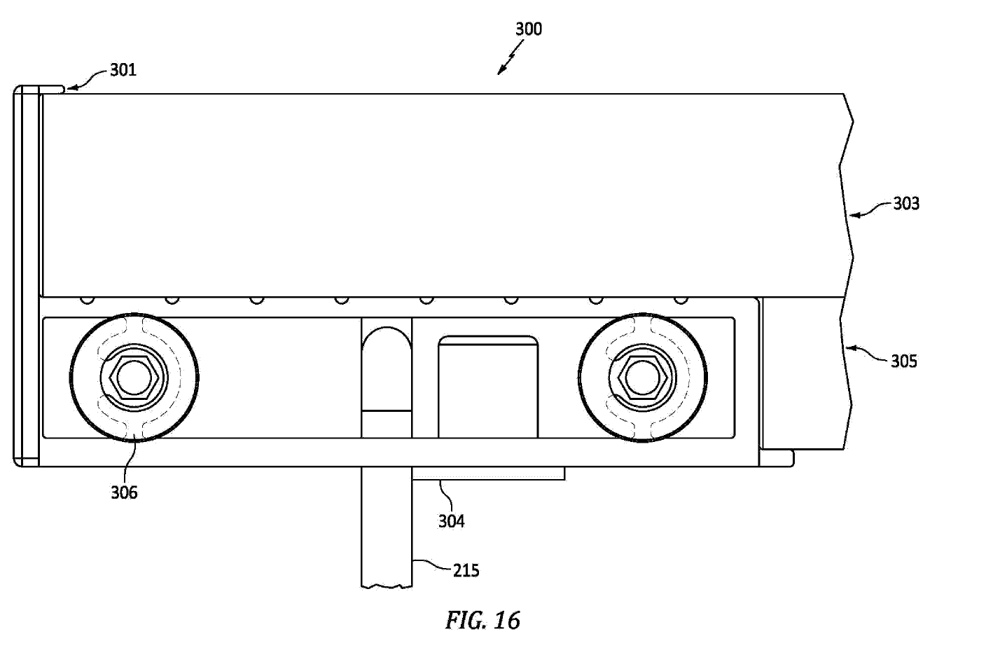

FIGS. 12-18 show an alternative embodiment of the cabinet door 300.

In this embodiment, the housing 301 is segmentally constructed and held to adjoining housing members 301' by set screws 306. The cabinet door 300 has a light diffuser plate 303 and a back plate 305, preferably formed from an aluminum honeycomb panel. The LED strip (not shown) is arranged such that light is emitted towards the middle interior space defined by the housing 301. In this alternative embodiment, the housing 301 has protrusions disposed on the front facing side extending inwardly and on the back facing side extending inwardly to secure the interior components of the cabinet door 300 in place. It is preferred that the front facing inwardly extending protrusion of the housing 301 extends minimally such that the display remains substantially seamless, and the back facing inwardly extending protrusion of the housing 301 is larger to house screws 306, wiring 215, and support the interior components from the back side. The housing 301 has a C-shape that when the cabinet door 300 is assembled, all components are secured by the housing 301.

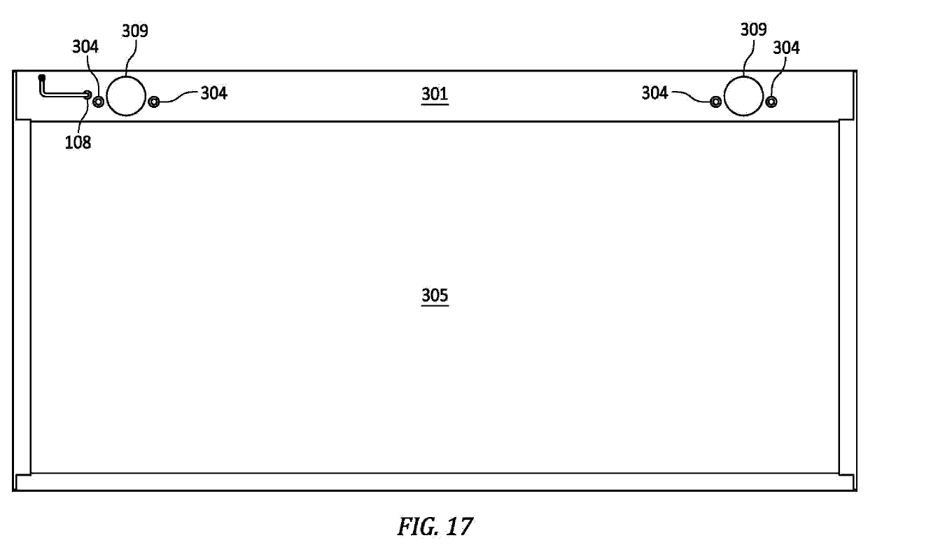

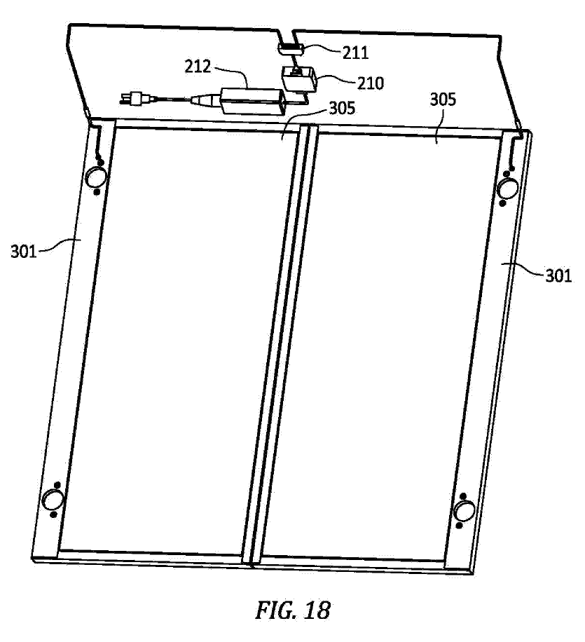

On the backside of cabinet door 300, as best seen in FIG. 17, the housing surrounds the back perimeter of the cabinet door 300, with the cabinet box attaching side being thicker to support the weight of the cabinet door 300. Further, attachment points 309 and riveted nuts 304 are disposed on the thicker portion for attachment to a cabinet door hinge. A wiring channel 308 is also disposed thereto for passing wiring 215.

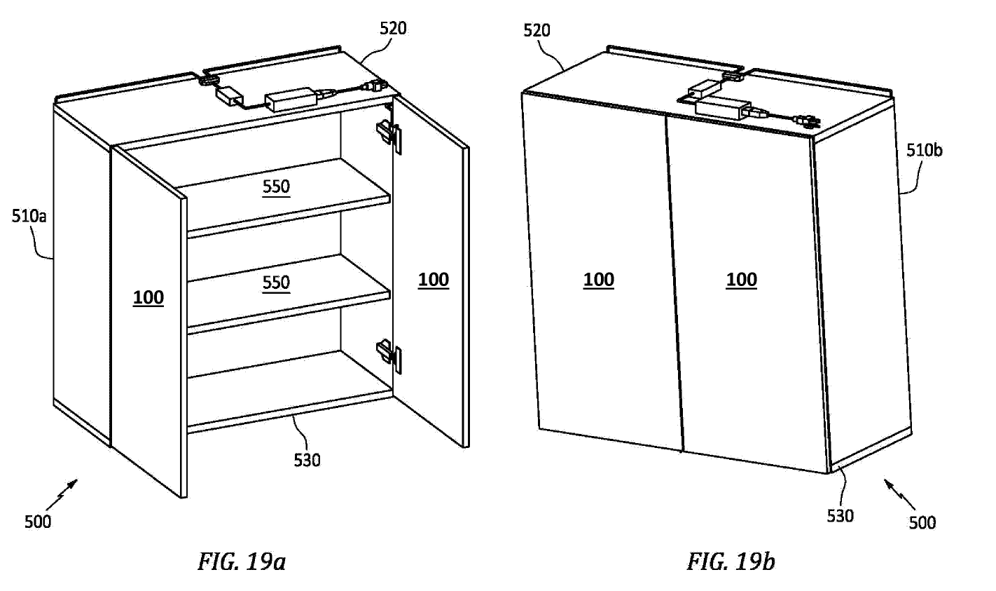

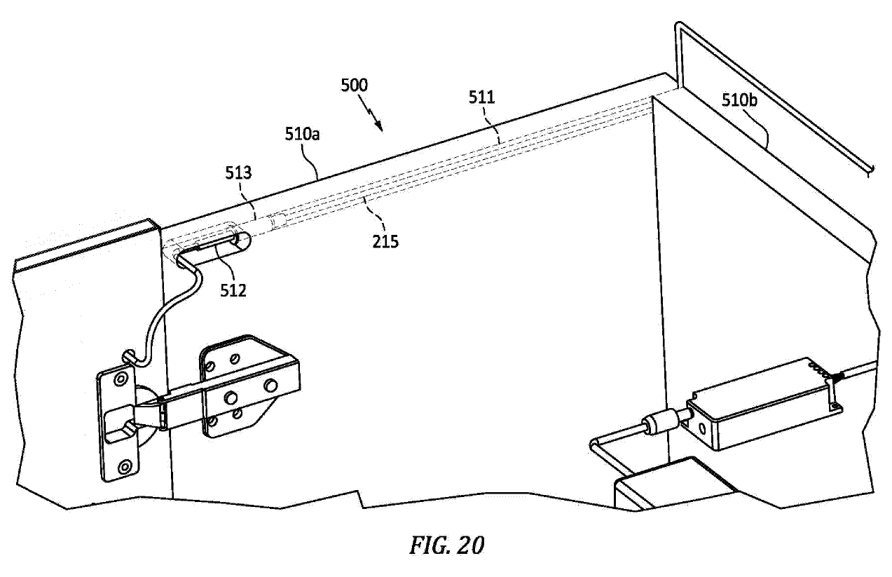

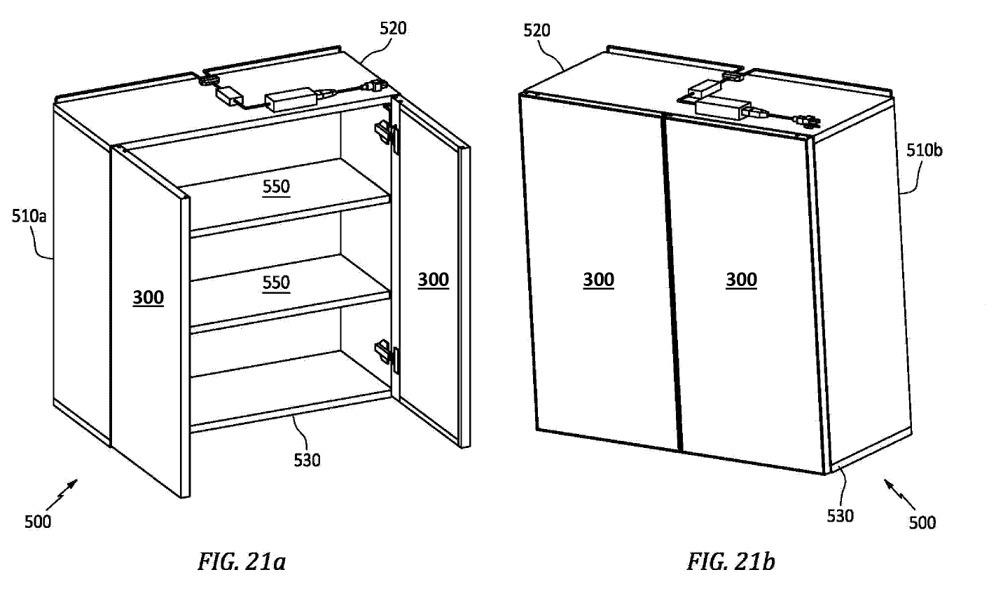

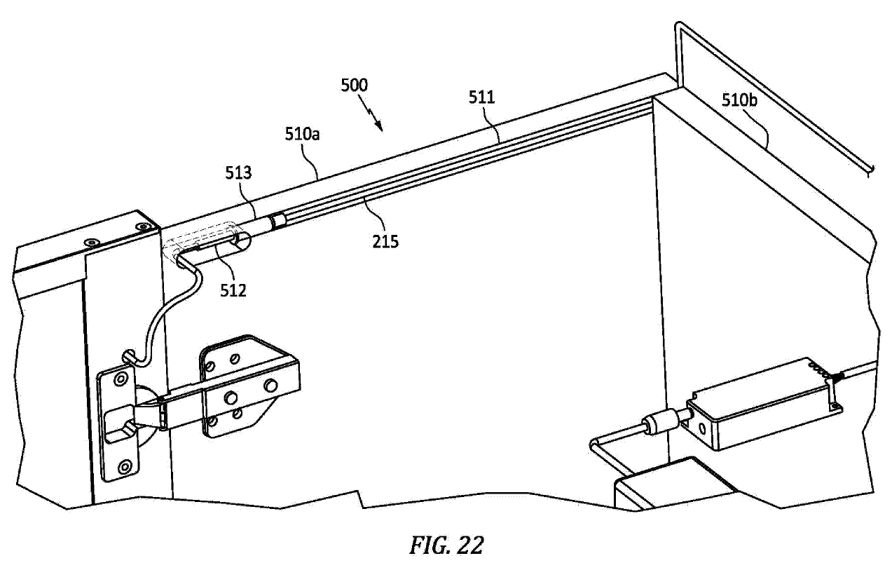

FIGS. 19a-20 depict a cabinet box 500 for use with cabinet door 100 and FIGS. 21a-22 depict a cabinet box 500 for use with cabinet door 300. Wiring of the control device 200 may be housed in the cabinet box 500. The cabinet box 500 may be dimensioned to any size to fit the space in which the cabinet box 500 is designed for. The cabinet box 500 can be formed from aluminum, wood, plastic, or any other material common in the construction of cabinetry. The cabinet box 500 has two sides panels 510a,b; top panel 520; bottom panel 530 and rear panel 540. Optionally, the cabinet box 500 may also have at least one shelf 550 disposed within the cabinet box 500. Side panels 510a,b may have a channel 511 routed within the interior of the panel 510a and/or 510b housing electrical wiring 215 for connecting the LED strip 102 to the external control device 200. A recessed portion 512 is disposed substantially near the door and approximately located at a height approximately the same as channel 108,308 on cabinet door 100,300. The channel spans the length of the panel 510a,b and terminates at a hole (not shown) located on the rear side of the cabinet box 500. While an embodiment shows the channel 511 extending in a linear path, it is contemplated that the channel may extend in any direction, or continue into an adjacent panel, and terminate at a hole located on any surface of the cabinet box 500, preferably a surface that is not seen by a user. In a preferred embodiment, the wiring disposed in the channel 511 may be segmented, comprising a male/female connector 513 located within the recessed portion 512 to allow for connection and disconnection of the electrical wiring 215 from the cabinet door 100,300 during assembly without needing a user to manually pass the electrical wiring 215 through the channel 511.

The preceding description of the present invention is merely exemplary and not intended to limit the scope thereof in any way. While kitchen cabinets capable of changing color is described, it is contemplated that other furniture doors, such as those found in entertainment centers, dry bars, and night chests, for example, may employ the color changing cabinet doors described herein.

What is claimed is:

1. A cabinet door, comprising:
a housing defining an outer perimeter of the cabinet door;
a light emitting diode (LED) strip situated on at least one inwardly facing side of the housing and emitting light toward an interior space defined by the housing;
a diffuser positioned within the interior space and configured to diffuse light emitted by the LED strip;
a back plate positioned behind the diffuser and within the housing; and
a control device operatively connected to the LED strip.

2. The cabinet door of claim 1, wherein the LED strip is disposed on two parallel inwardly facing sides of the housing.

3. The cabinet door of claim 1, further comprising a light-guide layer configured to direct light from the LED strip toward the diffuser and toward a front-facing direction of the cabinet door.

4. The cabinet door of claim 1, further comprising an L-shaped support plate disposed behind the light-guide layer and having a front-extending portion on which the LED strip is mounted.

5. The cabinet door of claim 3, wherein the cabinet door further comprises a reflective layer situated behind the light-guide layer.

6. The cabinet door of claim 1, wherein the cabinet door further comprises an acrylic layer situated in front of the diffuser.

7. The cabinet door of claim 1, wherein the back plate comprises a channel on a rear facing side thereof to allow wiring to pass through.

8. The cabinet door of claim 1, wherein the LED strip comprises LED sub-pixels capable of a variety of color options and independent control.

9. The cabinet door of claim 1, wherein the control device comprises a control box, an output device receptacle, and a plug.

10. The cabinet door of claim 9, wherein the control box houses a controller and memory.

11. The cabinet door of claim 10, wherein the control box houses a wireless communication interface.

12. The cabinet door of claim 9, wherein the output device receptacle is configured to connect to at least one LED strip of a cabinet door.

13. The cabinet door of claim 1, wherein two or more cabinet doors are configured to be electronically connected to enable synchronized control of a plurality of cabinet doors from a single input device.

14. The cabinet door of claim 13, wherein two or more cabinet doors are configured to be synchronized wirelessly.

15. The cabinet door of claim 3, wherein the housing is formed as a right angle protrusion extending in an inwardly facing direction and an outwardly front-facing direction, the backplate is secured in parallel to the inward-facing protrusion, the second outer diffusion layer is secured perpendicularly to the outwardly front-facing protrusion, the first inner layer is positioned in parallel between the backplate and the second outer diffusion layer, and the LED strip is secured to the outwardly front-facing protrusion and abuts the first inner layer.

16. The cabinet door of claim 15, wherein the cabinet door further comprises an acrylic layer adhered to the front facing side of the diffusion layer.

17. The cabinet door of claim 1, wherein the housing is banded around the outer edge of the cabinet door.

18. The cabinet door of claim 1, wherein the housing is segmentally constructed and secures the diffuser and back plate in place by a protrusion located on the front of the cabinet door and extending inwardly that secures the diffuser, and a protrusion located on the back of the cabinet door and extending inwardly that secures the back plate.

19. A cabinet box for use with the cabinet door of claim 1 comprising a channel for housing wiring.

20. The cabinet box of claim 19, wherein wiring is disposed within the cabinet box and is configured to connect an LED strip to an output device receptacle.
